(19) United States
(12) Patent Application Publication
(10) Pub. No.: US 2014/0224363 A1
(43) Pub. Date: Aug. 14, 2014

(54) CONTROL DISK FOR A MIXER FAUCET

(71) Applicant: Grohe AG, Hemer (DE)

(72) Inventors: Ole Benedikt KOSTORZ, Menden (DE); Stefan STEINHOFF, Sundern (DE)

(73) Assignee: Grohe AG, Hemer (DE)

(21) Appl. No.: 14/172,117

(22) Filed: Feb. 4, 2014

(30) Foreign Application Priority Data
Feb. 13, 2013 (DE) 10 2013 002 396.3

(51) Int. Cl. E03C 1/04; F16K 11/074

(52) U.S. Cl. CPC E03C 1/04; F16K 11/074
USPC 137/625.41

(57) ABSTRACT

A control disk for a control set of a sanitary mixing faucet, in each case with at least one through passage for cold water and hot water and an outlet for the mixed water and at least one through passage has a cross section that becomes smaller in the circumferential direction and extends over an angle (α) of at least 15°.

This nonprovisional application claims priority under 35 U.S.C. §119(a) to German Patent Application No. DE 10 2013 002 396.3, which was filed in Germany on Feb. 13, 2013, and which is herein incorporated by reference.

### BACKGROUND OF THE INVENTION

1. Field of the Invention

The present invention relates to a control disk for a control set of a sanitary mixer faucet in each case with at least one through passage for cold water and hot water and an outlet for the mixed water.

2. Description of the Background Art

Mixer faucets are already known in the conventional art in which a fixed flat disk has two water passages, one of which is designated for hot water and the other for cold water. A further disk is slidable and rotatable relative to said fixed disk, whereby the movable disk can completely cover and open the two through passages. The mixing ratio is determined by rotating the movable disk and the total volume of flowing water by sliding the movable disk. This type of mixer faucet is known, for example, from DE 34 19 208 A1, which corresponds to U.S. Pat. No. 4,617,965.

Greater requirements with respect to sensitivity are being placed to an increasing extent on modern mixer faucets. For example, the path or rotation angle that a lever end or a lever traverses between a mixer position with 34° C. mixed water and a mixer position with 44° C. hot water can be understood to be a characteristic of the sensitivity of a mixer faucet. The longer this path or the larger the rotation angle, the more sensitive and easier to adjust the mixer faucet. So-called sensitivity cams on the control disk, which bring about a reduction of the flow cross section, represent known approaches to increasing the sensitivity. However, the disadvantageous reduction of the flow in the cold and hot water stop is also associated with the reduction of the flow cross section.

### SUMMARY OF THE INVENTION

It is therefore an object of the present invention to solve at least partially the problems arising from the conventional art and in particular to provide an especially sensitive mixer faucet with a concurrently high flow.

In an embodiment, the object is attained by a control disk, which is characterized in that at least one through passage has a cross section that becomes smaller in the direction of movement of the movable control disk and extends over an angle of at least 15° or whose length is at least 0.15 times a total movement length. The length of the through passage, a short passage length, in this case is the path length in the direction of movement between an inlet edge and an outlet edge of the control disk. The total movement length is to be understood as the maximum length of any movement path that a control disk can traverse in a movement between two stop or maximum and minimum positions. In the case of a rotation, the direction of movement corresponds, for example, to a circular path. However, any other directions of movement such as those of linear translational or spatial movement paths can be taken. In this case, the cross section of the through passage can optionally be kept constant or made smaller in the direction from an open position to a closed position of the control set.

Instead of the known through passages, the present invention recognized that the sensitivity of the control disk and thereby of the entire mixer faucet is improved considerably by an elongated through passage. This is based on the fact that the change in state from a completely opened cross section to a completely closed cross section is divided by the invention into a much larger angle range or a much longer path distance of the lever. The longer the extension of the through passage and thereby the passage length, the greater also the sensitivity of the control disk. The invention has discovered that extensions of 15° or more based on the angle in the circumferential direction of the control disk have proven successful. Control disks substantially have a circular basic form, interrupted by functional regions. The angle range important for the invention is measured from a central axis of the circular cross section. In the case of geometries that are not circular, the angle range is measured in regard to the center of the area or the rotation axis of the operating lever.

The angle can be between 25° and 80°, whereby especially good results are achieved between 50° and 70°. In these angle ranges, a favorable ergonomics is assured, so that the user of the mixer faucet experiences the operation as pleasant and simultaneously as sensitive.

In the case of movement paths that are not circular, it is advantageous if the passage length is at least 0.3 times and preferably at least 0.4 times the total movement length.

It is provided further that the control disk can be designed as a fixed control disk for a mixing cartridge. The control disk therefore can be used in a control set of conventional mixing cartridges, without the other components having to be adapted.

It is especially advantageous further, if the cross section of the through passage becomes smaller in the direction of a hot water position. If in a thus designed embodiment of the through passage, for example, the operating lever moves from a totally cold water flow to a total hot water flow, a movable control disk lying on the fixed control disk with increasing movement closes the cold water through passage. In this case, the cross section of the through passage is reduced according to the rotational movement. At the same time, however, the water flows also in the circumferential direction through the cross section of the through passage, which depending on the application may have a constant or a gradually decreasing cross section. The cross section of the through passage thus can be adapted to the specific requirements.

Depending on the application, it can be provided that the through passage can have at least a partial base, which has a constant height in the direction from an inlet edge to an outlet edge or increases by an optionally average defined angle of inclination. In particular, especially sensitive variants of the control disk can be achieved with a slight rise of the base.

It is advantageous further, if the base has an average angle of inclination of less than 45°, preferably of less than 30° in the circumferential direction. The average angle of inclination is critical for the present invention. If smaller structures are used, this average angle of inclination can be approximated, for example, also by vertical and horizontal or any inclined smaller area sections. In connection with the present invention, smooth surfaces are not necessarily required. Average angles of inclination of, for example, 20° to 25° have proven especially successful in practice. As a result, the through passage during an adjustment movement experiences a slow but nevertheless sufficiently great reduction.

For problem-free fabrication, it is advantageous, moreover, if a jump zone on the base is provided at least in the area of the inlet opening or outlet opening. Whereas the wall thickness of the base can be especially small in the area of the inlet opening, in the area of the jump zone, for example, a jump in the wall thickness can occur, which maintains the necessary minimum wall thickness of the base area of the through passage. In addition, if required a jump zone can also be provided in the area of the outlet openings. For instance, this is the case if a selected angle of inclination is selected as especially flat. The height of the jump zones, however, should not exceed a height of 25% of the construction height of the control disk. In addition, the jump zones should not extend in the circumferential direction over an area of more than 25% of a total length of the through passage.

Also, the control disk of the invention can be used in a control set for mixing cartridges and also together with such a mixing cartridge in a mixer faucet, which as a result have an especially high adjustment movement sensitivity.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a control set of the invention in an oblique view;

FIG. 2 shows a control disk of the invention in an oblique view;

FIG. 3 shows a plan view of the control disk according to FIG. 2;

FIG. 4 shows a plan view of the control set according to FIG. 1;

FIG. 5 shows a plan view of the control disk according to FIG. 2 with concealed edges;

FIG. 6 shows a plan view of an opened control set according to FIG. 1 with concealed edges;

FIG. 7 shows a sectional diagram A-A through the control set according to FIG. 6;

FIG. 8 shows the control set according to FIG. 1 in a partial sectional view; and

FIG. 9 shows a control set with a relative linear movement.

### DETAILED DESCRIPTION

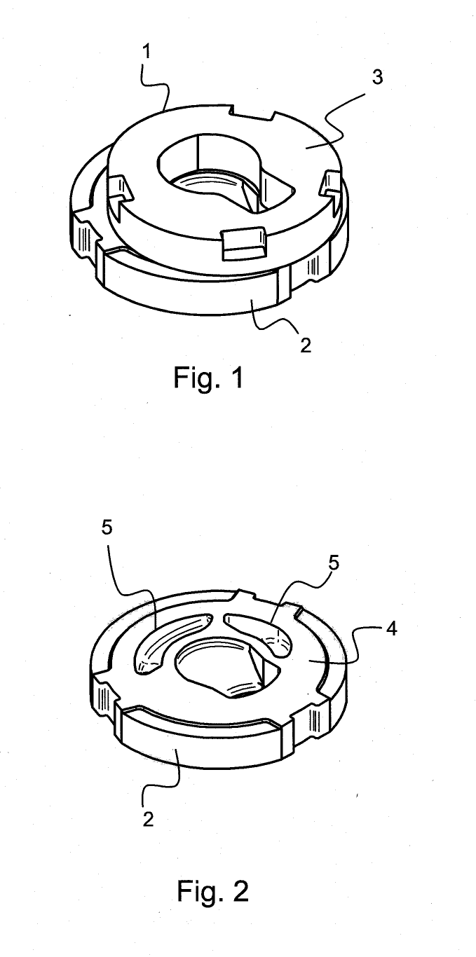

A control set 1 of the invention with a fixed control disk 2 and a movable control disk 3 is shown in an oblique view in FIG. 1. In the shown relative position to one another the two control disks 2, 3 are installed within a mixing cartridge (not shown). FIG. 1 shows control set 1 in a closed state.

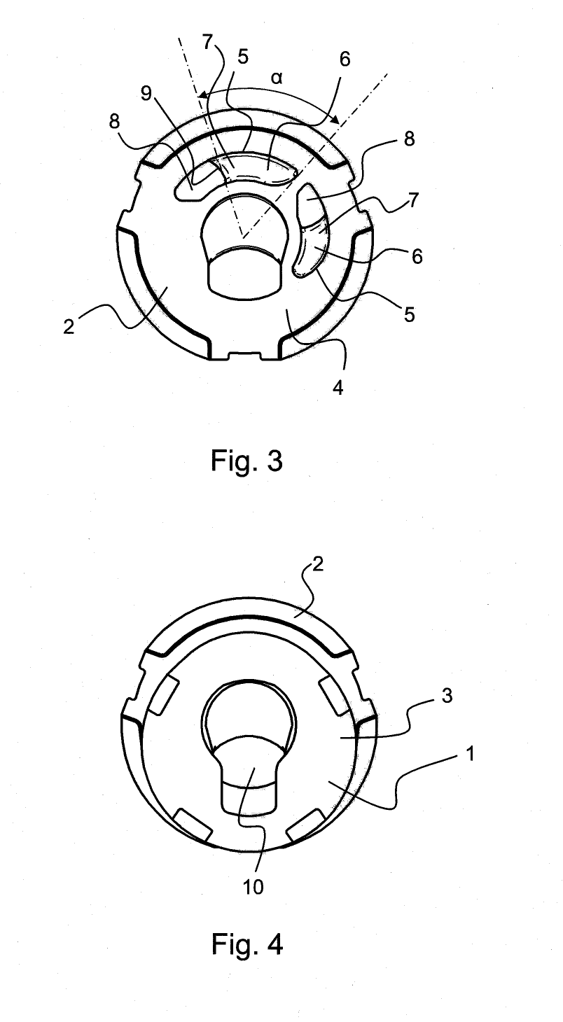

In the closed state, movable control disk 3 covers outlet openings 5, which are located on an outlet side 4 for cold and hot water and are shown in FIG. 2, and thus blocks the water flow. Fixed control disk 2 according to FIG. 2 is again shown in a plan view in FIG. 3. Outlet openings 5, located on outlet side 4, can again be easily seen. The plan view shows further a base 6 of a through passage 7. Further, in the plan view, partially concealed inlet openings 8 can be seen, which lie on an inlet side 9 on the bottom side of fixed control disk 2. Through passage 7 extends in a circumferential direction of fixed control disk 2 over an angle range α. Whereas the invention can be realized in a very large angle range between 25° and 80°, the shown embodiment lies within the preferred angle range between 50° and 70°. As can be readily seen in FIG. 3, moreover, different passage lengths can be selected for the two through passages 7, so that the cold water and hot water are conducted through through passages 7 of different length.

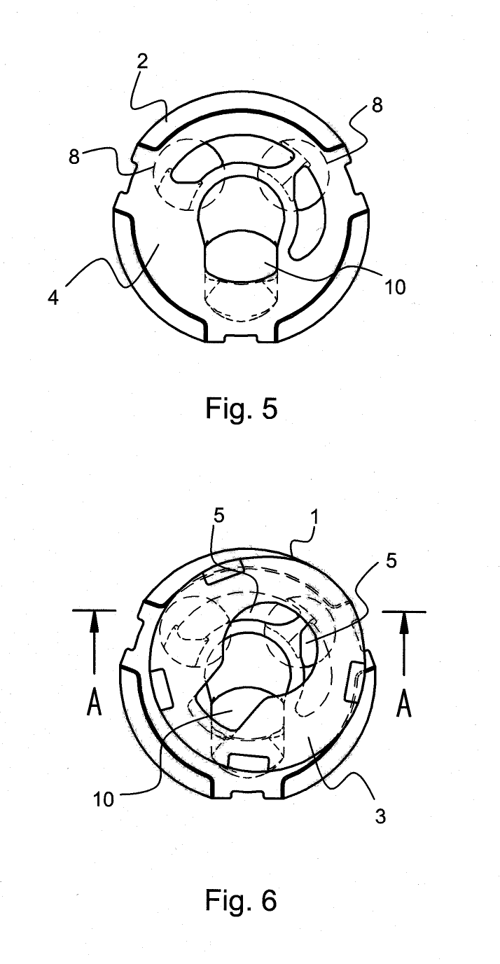

Control set 1 according to FIG. 1 is again shown in a plan view in FIG. 4, whereby it can be easily seen that movable control disk 3 lies on fixed control disk 2 so that both outlet openings 5 are closed. Only an outlet 10 for the mixed water is always open in all movement states.

In FIG. 5, fixed control disk 2 according to FIG. 3 is again shown with concealed edges, indicated by dashed lines. The circular design of the inlet openings through which the hot or cold water can flow into fixed control disk 2 can be easily seen here.

In FIG. 6 control set 1 opened in a mixing position is again shown with concealed edges. Movable control disk 3 in this position partially frees both outlet openings 5, so that in each case the cold and hot water stream can flow in and flow out again as mixed water out of the mixing cartridge via outlet 10.

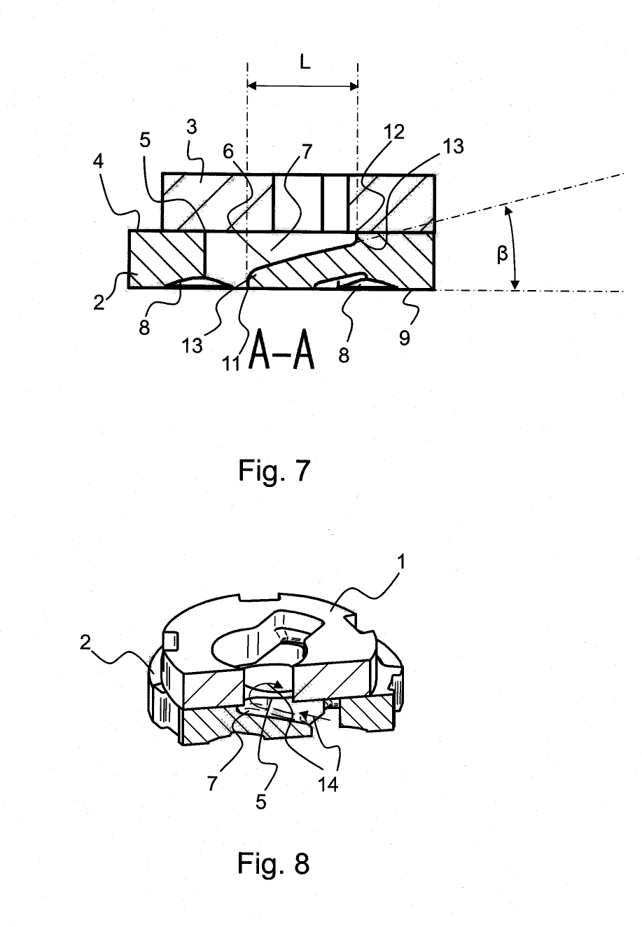

The sectional diagram in FIG. 7 is along the line A-A according to FIG. 6. Movable control disk 3 thereby lies in a planar manner on fixed control disk 2. The two circular inlet openings on inlet side 9 of fixed control disk 2 can again be seen. Through passage 7 is formed between an inlet edge 11 and an outlet edge 12. Through passage 7 has the length L, whereby base 6 is inclined by an angle of inclination (β) of less than 30°. The length L in this case is measured parallel to the inlet (9) or outlet side (4) of the control disk (2). The angle of inclination in the embodiment shown here corresponds, for example, to about 15°. There are very small jump zones, in which the average angle of inclination is exceeded, in the area of inlet edge 11 and outlet edge 12. These jump zones are relatively short, however, in comparison with the length of through passage 7.

In FIG. 8, control set 1 of the invention according to FIG. 1 is again shown in a partially cut-open state. It can be easily seen how the water stream flowing in the direction of arrow 14 flows through through passage 7 and is thereby restricted as soon as movable control disk 3 turns clockwise. With this rotation, the cross section of outlet opening 5 is reduced at the same time as well as the cross section of through passage 7, as a result of which the especially sensitive adjustability is achieved.

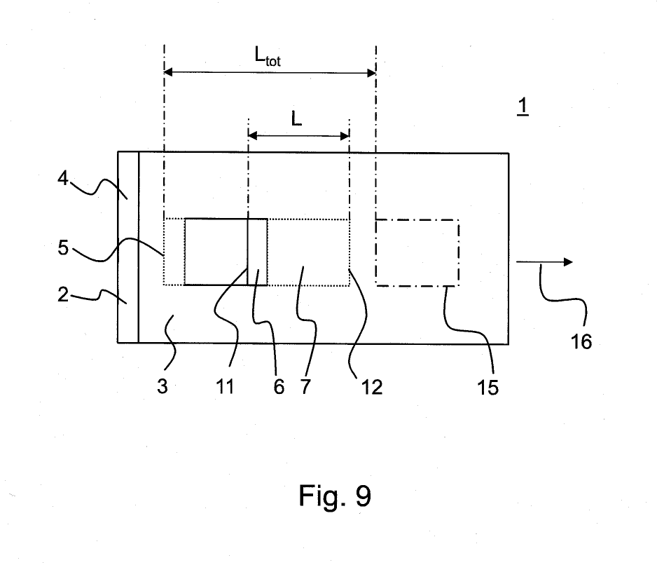

In FIG. 9, finally a further embodiment of a control set (1) of the invention is shown in a plan view, in which overlying movable control disk (3) is moved somewhat along a linear directional path, according to the arrow (16), toward the right relative to the immovable and underlying fixed control disk (2) and lies on outlet side 4 thereof. The contour, partially covered by movable control disk (3), of through passage (7) is shown by means of the dashed line. Both outlet opening (5) and outlet edge (12) are shown concealed in this way. Passage length (L) is stretched between inlet edge (11) and outlet edge (12); in the shown exemplary embodiment it has approximately the 0.5-fold length of the total movement length (Lₜₒₜ). The total movement length (Lₜₒₜ) extends from a first extreme position (completely open) to a second extreme position (blocking position) of movable control disk (3). The second extreme position in the present case is shown by the dashed line of blocking position 15. No water can flow through the control set in the blocking position.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A control disk for a control set of a sanitary mixer faucet, the control disk comprising:
at least one through passage for cold water and hot water; and
an outlet for mixed water,
wherein the at least one through passage has a cross section that becomes smaller in a direction of movement of a movable disk, and
wherein the through passage extends over an angle of at least 15° or over a length, the length being at least 0.15 times a total movement length.

2. The control disk according to the preceding claim, wherein the angle is between 25° and 80° or between 50° and 70°.

3. The control disk according to claim 1, wherein the length is at least 0.3 times or at least 0.4 times a total movement length.

4. The control disk according to claim 1, wherein the control disk is a fixed control disk for a mixing cartridge.

5. The control disk according to claim 1, wherein the cross section of the through passage becomes smaller in a direction of a hot water position.

6. The control disk according to claim 1, wherein the through passage has at least a partial base that has a constant height in a direction from an inlet edge to an outlet edge or increases by an angle of inclination.

7. The control disk according to claim 6, wherein the partial base has an average angle of inclination of less than 45° or less than 30° in a circumferential direction.

8. The control disk according to claim 1, wherein a jump zone is provided at least in an area of the inlet opening or outlet opening.

9. A control set for mixing cartridges comprising a control disk according to claim 1.

10. The control disk according to claim 1, wherein the control set is a mixing faucet control set.
